(19) United States
(12) Patent Application Publication
(10) Pub. No.: US 2024/0412148 A1
(43) Pub. Date: Dec. 12, 2024

(54) Polymatic Systems and Methods for Optimizing Supply Chains

(71) Applicant: ketteQ Holdings, Inc., Atlanta, GA (US)

(72) Inventor: Andrey Kornienko, Les Escaldes (AD)

(73) Assignee: ketteQ Holdings, Inc., Atlanta, GA (US)

(21) Appl. No.: 18/430,754

(22) Filed: Feb. 2, 2024

Related U.S. Application Data
(60) Provisional application No. 63/442,764, filed on Feb. 2, 2023.

(51) Int. Cl. G06Q 10/067; G06Q 10/0637; G06Q 10/0639; G06Q 10/08

(52) U.S. Cl. CPC G06Q 10/067; G06Q 10/06375; G06Q 10/06395; G06Q 10/08

(57) ABSTRACT

Methods and systems for supply chain optimization utilizing a polymatic solver architecture. Data is entered into a memory device. A graph network model is applied to the data to create a neural network. The neural network is parsed to divide the neural network into a plurality of subnetworks. Each subnetwork is sent to a job execution component. Each subnetwork is processed to produce a plurality of subnetwork scenarios. The subnetwork scenarios are superimposed to identify an optimum supply chain scenario. The optimum supply chain scenario is implemented as a plan.

### CROSS-REFERENCE TO RELATED APPLICATIONS

This application claims priority to U.S. Provisional Patent Application No. 63/442,764, filed Feb. 2, 2023, which is hereby incorporated by reference in its entirety.

### BACKGROUND

Manufacturing resource planning (“MRP”) broadly describes the methodology by which manufacturers allocate and plan the use of resources to achieve an objective. It is common to think of MRP in association with the production of products, but the principles inherent to MRP are applicable to other areas, which require planning. For instance, inventory management, human resources management, providing professional services, and running a distribution network may benefit from one or more of the principles embodied in MRP. Further, MRP does not necessarily have to be limited to the producing or moving tangible things. The principles inherent to MRP could be applied to the planning and use of resources to accomplish any goal. The discussion herein will primarily focus on product fulfillment, but the principles herein are applicable to the planning and execution of a multitude of projects and goals.

Supply chain management is a component of MRP and generally relates to how resources (e.g. parts, components, services, etc.) are allocated in order to fulfill a demand. A demand in one example could be an order for a product. However, a demand could also be the requirement for one or more components that are used for fulfillment of a product. One example would be demand for a product, such as a table. A simple table may require a surface and four legs. The table may also require, nuts, bolts and brackets to attach the legs to the surface. In addition, completion of the table may require a service, such as painting of the table, and the service may require a resource, such as paint. Therefore, a simple table may have a bill of material (“BOM”) including a surface, legs, brackets, nuts, bolts, painting (e.g. spray booth capacity), and paint.

In addition, the resources within the BOM may be considered a demand in and of themselves. For instance, paint is utilized in a number of different applications. Paint may be used on tables, but it may also be used in other products. Paint is composed of multiple ingredients so paint is subject to its own supply chain. Therefore, management of the supply chain for an object using paint also to some extent also involves managing, or at least understanding, the supply chain for paint. Supply chain management planning and software applications are utilized to manage and plan supply chains for numerous entities, including manufacturers, suppliers (who may also be manufacturers), and sellers of products. Supply chain management broadly involves analyzing demands, determining the resources needed to fulfill the demands, and planning how to fulfill the demands in an optimal way. An illustrative approach to supply chain management is provided in United States Patent Publication No. 20130262176A1, entitled “Hybrid Balancing of Supply and Demand”, which is hereby incorporated by reference in its entirety.

One problem associated with prior approaches is that they tend to approach supply chain management from a one-dimensional perspective. They use a relatively simple methodology by which demands are broken down into levels. The demands are then analyzed in one of two ways. Each demand is analyzed either in a level-by-level manner (breadth first) or in demand by demand manner (depth first). There are also hybrid solutions which analyze combination of breadth and depth, but at heart these are really quasi two-dimensional systems. For example, a problem may be analyzed on a particular level to determine a particular demand to analyze using a depth-by-depth approach, but then the process returns to the level by level approach. There are problems with the preceding approaches. First, analyzing demands using a depth-by-depth approach is time consuming. Often, while a demand is being analyzed the environment has changed. For example, additional orders have arisen or the supply of components may have been affected by some unforeseen variable. The breadth first approach may be faster than the depth first approach in certain circumstances, but breadth first approaches tend be less efficient at taking into account multiple sources for a particular resource. Accordingly, what is needed are polymatic systems and methods for optimizing supply chains.

### BRIEF DESCRIPTION OF THE DRAWINGS

A more detailed understanding may be had from the following description, given by way of example in conjunction with the accompanying drawings wherein:

FIG. 1 illustrates one example of network graph representing one exemplary aspect of a supply chain;

FIG. 2-5 illustrate the network graph shown in FIG. 1 with a processing window shown to depict processing of the network graph;

FIG. 6 depicts an exemplary computing environment to analyze the network graph of FIG. 1;

FIG. 7 is an exemplary block diagram representing a computer system in which aspects of the processes and systems disclosed herein or portions thereof may be incorporated.

### SUMMARY

In one embodiment, a method is provided. In one example, data is entered into a memory device. A graph network model is applied to the data to create a neural network. The neural network is parsed to divide the neural network into a plurality of subnetworks. Each subnetwork is sent to a job execution component. Each subnetwork is processed to produce a plurality of subnetwork scenarios. The subnetwork scenarios are superimposed to identify an optimum supply chain scenario. The optimum supply chain scenario is implemented as a plan.

In one embodiment, a system is provided. The system includes a CRM application, a container based computing environment, and a polymatic solver application. Data is received from the CRM application. The data is analyzed to create a model of a supply chain network. The model is sent to a container based computing environment which is utilized to create an optimal supply chain management plan.

In one embodiment, a method is provided. Data representing orders for a product or service is received. A bill of material is determined for the product or service that includes a plurality of subcomponent demands for the product or service, which are elements needed to fulfill the product or service. A graph network model is utilized to model the subcomponent demands into a neural network. The neural network is analyzed to determine if the neural network can be split into subnetworks. The neural network is split into subnetworks if the neural network can be split. Data representing the subnetworks is sent to a container based execution environment. The container-based execution environment is utilize to create an optimal supply chain plan for each of the subnetworks. The optimal supply chain plans are assembled into a single supply chain plan.

### DETAILED DESCRIPTION

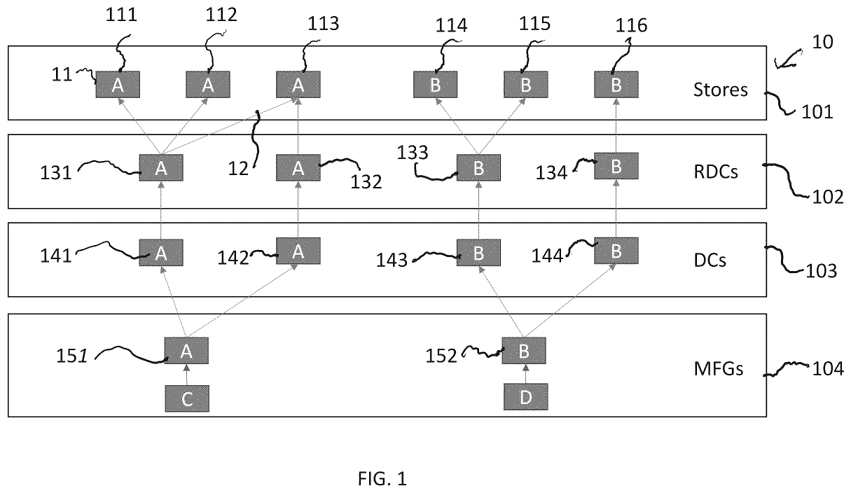

Referring to FIG. 1, an exemplary diagram is shown that describes a typical demand planning process. The diagram shown in FIG. 1 is provided for illustrative purposes only and the context described therein should not be construed therein as limiting the principles described herein to a particular embodiment or environment. In addition, due to the complexity associated with demand planning, it should be understood that a limited subset of levels and demands are shown for illustrative purposes and brevity. It should be understood that the levels and/or demands could number n, wherein n is a number that ranges from 1 and increases linearly or exponentially and is bound by factors such as the design of the system, computer resources, and the like. To put it another way, at some point, when constructing a supply chain demand planning process, it becomes desirable to set levels and subcomponents. For instance, the designer may stop when raw materials, which are not dependent on other materials are described, or the designer may stop when a certain level of component supply is reached—for example, a staple component. The principles described herein are meant to apply to both simple and large-scale systems.

Referring further to FIG. 1, a supply chain map or network 10 is shown. In one example, network 10 is constructed through using a nodal graph library with supply chain characteristics. Therefore, network 10 in one example may include a plurality of nodes 11. The nodes may be connected by edges 12. In one example, a node 11 may represent an entity that may produce something meaningful in a supply chain context. A node 11 in one example may be a manufacturing facility, a retail store, a distribution center, and the like. A node 11 is not limited to a geographical place. For instance, a node 11 may comprise an entity such as a corporate supplier that is distributed over multiple geographic locations. A node 11 may be a high level or granular descriptor for an entity. A node may be elemental or encompass multiple elemental components. For example, one node 11 may represent raw material from a particular mine and another node 11 may represent the same raw material from another mine. In another example, one node 11 may represent a product produced from a manufacturing site and another node 11 may represent another product produced from another manufacturing site. The definition of node 11 in one embodiment considers the relevant characteristics as defined by the users of the systems defined herein.

Referring further to FIG. 1, edges 12 represent the capability of traversal from one node 11 to another. In another example, an edge 12 may represent a value or weight associated with traversal from one node 11 to another. For instance, there may be a cost or time value associated with going from one node to another. The time and/or cost may be represented by the edge. The preceding example of purposing a neural network with supply chain data are provided for illustrative purposes only and should not be construed as limiting. Typically, the values associated with traversing from one node to another are provided by the entities associated with fulfilling function embodied by the node. For example, a manufacturer may provide the length of time and cost associated with producing a product or component. Nevertheless, other sources of data may be utilized as well. One example may be weather. If a manufacturer is present in a hurricane zone, then applicable hurricane data may be used to weigh the cost and time necessary to produce a component. Other factors, such as historical data (e.g., a manufacturers track record with a customer), political conditions, and labor unrest, may also be used.

Referring further to FIG. 1, in an exemplary embodiment, a plurality of levels are shown. Level 101 represents a plurality of stores, level 102 represents a plurality of regional distribution centers, level 103 represents a plurality of global distribution centers, and level 104 represents a plurality of manufacturers (“MFGs”). The stores, distribution centers, and MFGs are represented as nodes 11. Within each node is an “A” or “B”, which each represent a different product, component, and or thing. RDCs (level 102) distribute As or Bs to stores (level 101). Global distribution centers (level 103) distribute As or Bs to RDCs (level 102). Manufacturers (level 104) produce the As and Bs. To produce the products, manufacturers may rely on one or more supply chains (not shown), which may utilize additional resources, which are described for brevity as nodes having a “C” and “D” in FIG. 1. The context provided in FIG. 1 (distribution) has been used to provide an exemplary “real world” context for illustrative purposes. However, product As and Bs could represent another sort of demand. For purposes of further discussion As and Bs may be interchangeably referred to as “demands”.

Referring further to FIG. 1, each demand will have certain parameters associated with it. For instance, if a demand is associated with a product, parameters may include requirements, such as a volume of units, a priority level, and a delivery date. In the example shown demand A may be for a product with a desired delivery date of June 1 (to level 101), a priority level of high, and a volume of units of 1000. Demand B may be for a product having a desired delivery date of June 15^{th} (to level 101), a priority level of low, and a volume of 3000. To accomplish the preceding objectives, certain amounts of products will have to be at RDCs (level 102) and DCs (level 103), and manufactured (level 104) by certain times. Accordingly, each level will have certain requirements associated with it. The systems and methods described herein operate to produce various scenarios. The scenarios are evaluated to determine one or more optimal scenarios that may be executed as a plan by an entity responsible for fulfilling a demand.

Evaluating scenarios involves generating scenarios and then comparing the scenarios to the requirements of the end user. The end user may then select a scenario as a plan based on the predetermined criteria. In some examples, scenarios may not meet the criteria of the end user so the closes possible scenario may be used. In prior systems, generating multiple scenarios is a pain staking process because each scenario must be processed in its totality before moving to another scenario. The present systems and methods operate faster and more efficiently by utilizing a neural graph of a supply chain to break the supply chain scenarios into multiple pieces, which can then be processed simultaneously. The results are then stitched together or superimposed upon each other to produce optimal scenarios. Further, because the processes are run in parallel, each process may be run using multiple iterations using multiple values for the same parameters. Therefore, one calculation of one scenario does not have to wait until another scenario is complete before execution. Also, because the scenarios are broken into smaller components, parallel processing is not prohibitive from a cost perspective because the smaller pieces do not require massively parallel computational resources to generate each scenario. A plurality of smaller components are executed and then outputs are assembled into scenarios.

Referring further to FIG. 1, in one example there are three stores 111, 112, and 113, which require A in accordance with certain parameters and three stores 114, 115, and 116, which require B in accordance with certain parameters. Stores 111, 112, and 113 may receive A from RDC 131. Store 113 may also receive A from RDC 132, but not RDC 131. RDC 132 can only supply A to store 113. Similarly, RDC 131 can only receive A from DC 141 and RDC 132 can only receive A from DC 142. DC 141 and DC 142 receive A from MFG 151. Referring further to FIG. 1, stores 114, 115, may receive B from RDC 133. Store 116 can only receive product B from RDC 134. RDC 133 can only receive product B from DC 143 and RDC 134 can only receive product B from DC 144. DC 143 and DC 144 receive product B from MFG 152.

Referring to FIG. 1, determining an optimal balance for fulfilling the requirements described above with respect to FIG. 1, involves determining based on available factors, such as available supply and demand, projected (or potential) supply and demand, inventory, cost, time to fulfillment, etc. and optimal balance for fulfillment of orders. For example, with respect to product A, it may be desirable to fulfill the entirety of the order through use of RDC 131 because it will be faster than if RDC 132 were used. On the other hand, utilizing RDC 132 for 25% of the demand may take longer, but there may less cost associated with fulfilling the demand. Therefore, the balance of time and cost may be more optimal utilizing RDC 131 and 132. On the other hand, RDC 131 may only receive product A from DC 141. DC 141 may be experiencing significant delays receiving product A from MFG 151. Therefore, it may be desirable to bypass DC 141 to the greatest extent possible. Accordingly, it may be desirable to use DC 142 to the greatest extent possible and send less of product A to stores 111, 112 and maximize what is sent to store 113. The systems and methods describe herein operate to evaluate network 10 defined in FIG. 1 to provide one or more scenarios that are optimal for the given supply chain at a particular time.

The metrics used to determine an optimal solution are dependent on end user requirements. A manufacturer, supplier, or retailer of goods, for example, will define requirements that are important to it. For example, one entity may be concerned primarily with cost and another entity may be concerned primarily with time to fulfillment. Another entity may be concerned both but may weigh each differently than another entity. The systems and methods described herein are able to provide end users with multiple scenarios for fulfillment of demand in novel and more efficient manner than prior width, breadth, and hybrid systems. Furthermore, the optimal solution will also depend on the supplier's ability to produce a given result. For instance, a certain manufacturing site will have certain capacity or a distribution site will have a certain turnaround time. The system will determine what is possible given supplier constraints and evaluate what is possible against end user demand.

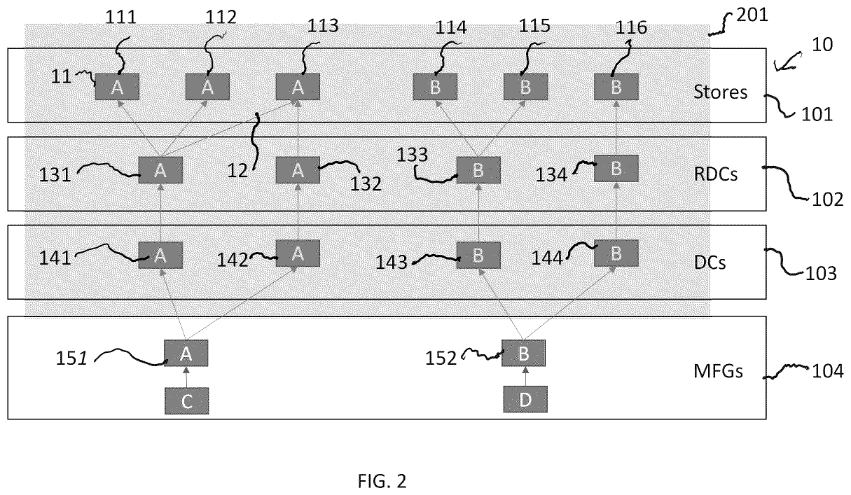

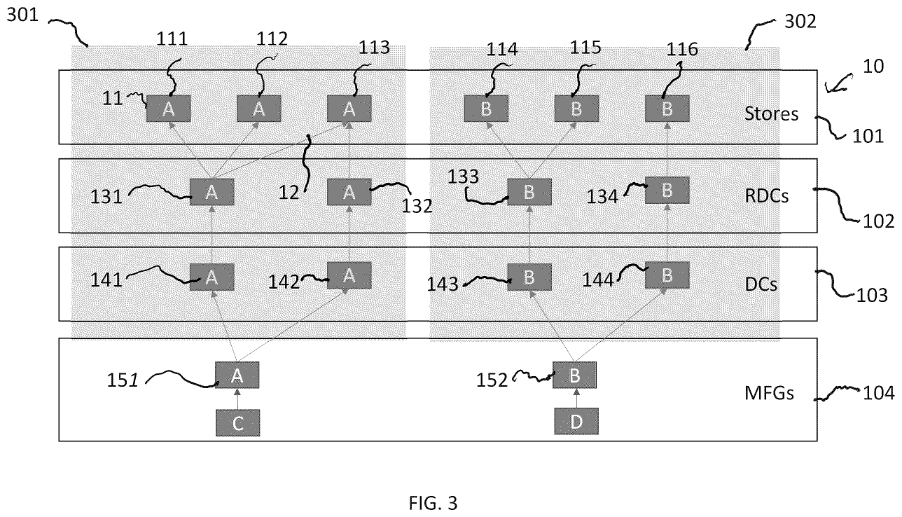

Referring to FIG. 2, the systems and methods describe herein utilize the concept of parsing the network 10 shown in FIG. 1 to define as many parallel processes as possible. In FIG. 2, a processing window 201 is shown to illustrate how the network 10 is parsed. In the example shown, the first three levels 101, 102, 103 are analyzed first. Three levels are shown for illustrative purposes only. Depending on the number of levels in the network 10 and other factors, more levels or less levels may be parsed at a time. In parsing network 10, it may be determined that A and B have no relevance to each other because they do not share common nodes. Accordingly, network 10 is split. Referring to FIG. 3, network 10 is depicted as split into subnetwork 301 and subnetwork 302. Reference to “splitting” network is a figurative expression, which means that the “portions” of the network that are “split” may undergo processing that is distinct from each other. In other words, they represent subcomponents of network 10 that may be processed as subcomponents.

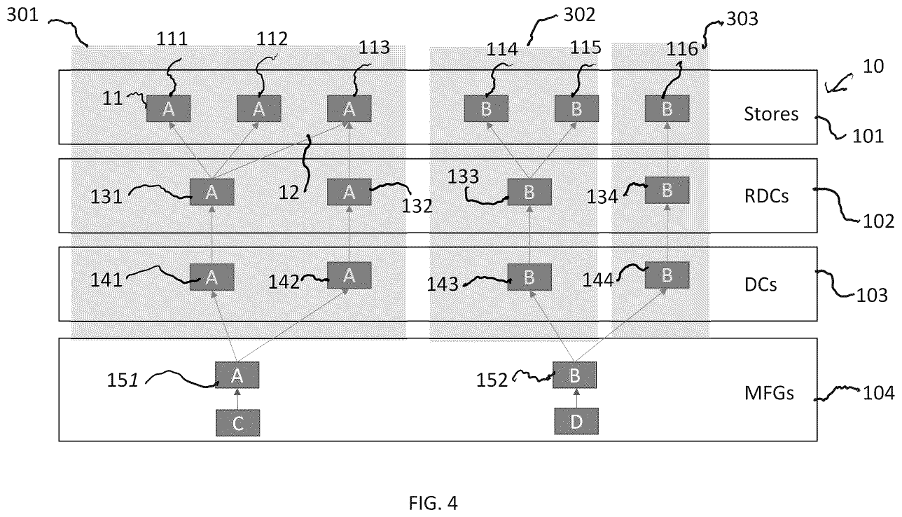

After splitting network 10 into subcomponent 301 and subcomponent 302, the subcomponents are parsed to determine if they may be further split. In one example, subcomponent 302 can be split again because the paths to stores 114, 115 are not dependent on the path to store 116. Referring to FIG. 4, network 10 is shown as subcomponent 301, subcomponent 302, and subcomponent 303. Once no further splitting is possible, subcomponent 301, subcomponent 302, and subcomponent 303 are processed and subcomponent forecasts are generated: The forecast for providing demand A to node 111, 112, and 113 is calculated, the forecast for demand B to nodes 114, 115, and the forecast for demand B to node 116 are calculated as parallel processes.

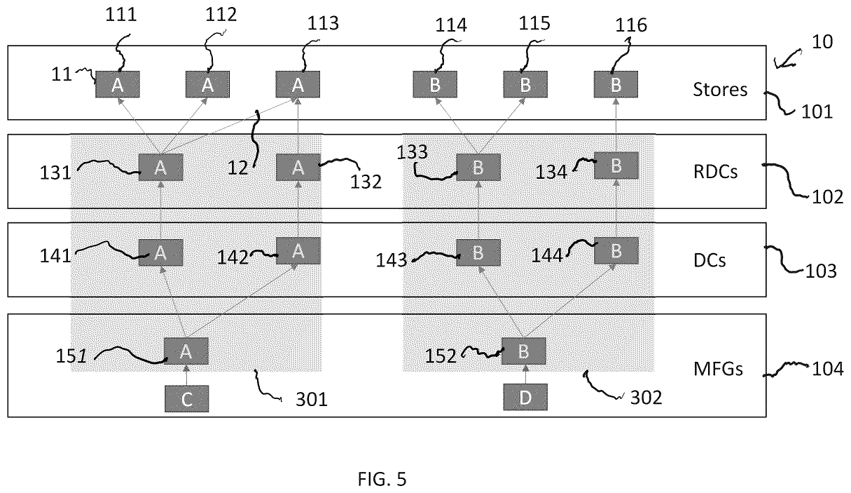

Referring to FIG. 5, once processing is complete on subnetwork 301, subnetwork 302, and subnetwork 303 processing window 201 advances downward to encompass level 102, level 103, and level 104. The levels within processing window 201 are evaluated for splitting. It can be seen that no splitting, other than subnetwork 301 and subnetwork 303 is possible because the nodes therein are dependent on each other. Therefore, subnetwork 303 is consumed back into subnetwork 302. The subcomponent forecasts are then processed for subnetwork 301 and 302 (at levels 102, 103, and 104) in parallel. Upon completion of processing, the results of the subcomponent forecasts may be superimposed to create scenarios, which may then be evaluated to determine the optimal plan for fulfillment of demand A and demand B.

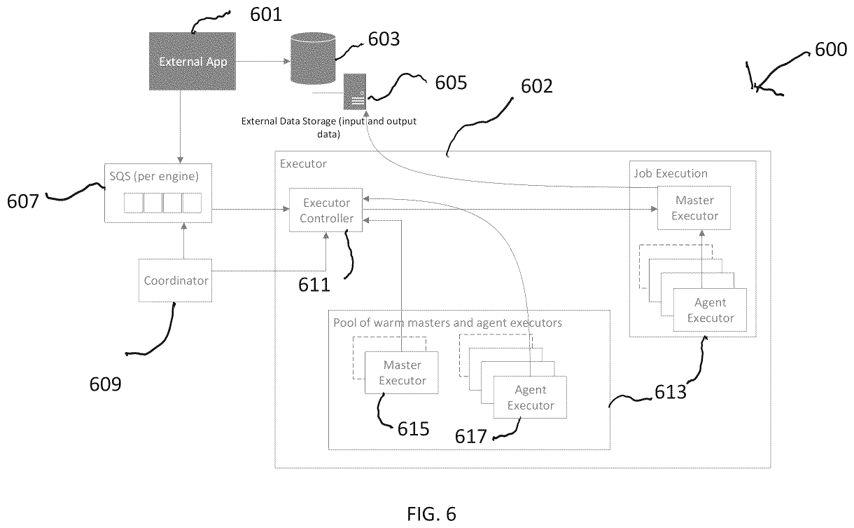

Referring to FIG. 6, an exemplary system 600 for executing the preceding methodology is shown for illustrative purposes. System 600 in one example comprises an external application 601, an execution environment 602. External application 601 in one example is polymatic solver application. External application 601 in one example is the application environment or software through which an end user or operator of system 600 interfaces therewith. External application 601 in one example includes a user interface that is connected to one or more data storage devices 603 and input/output devices 605. A user inputs data representing network 10 through external application 601. For example, a user may input demands, and the information that is used to populate the nodes 11 and edges 12 of network 10. For example, the possible manufacturing sites or distribution centers, and the parameters associated therewith, for fulfilling the demand. In one example, external application 601 may be connected to other applications that have pertinent information for generating scenarios. For instance, external application may be connected to customer relationship management (CRM) software, such as Salesforce® identifying data signifying present and future demand from customers, or manufacturing software of suppliers with data signifying current manufacturing capacity.

Referring further to FIG. 6, external application 601 populates data representing the supply and demand parameters using a graph library into network 10. External application 601 parses network 10 as set forth above to identify the various parallel processes. Data representing network and the parallel process are stored cache 607. Execution environment 602 utilizes the data in cache 607 to analyze network 10. A coordinator component 609 then coordinates the processing by sending the processes to executor controller 611, which then sends the processes to job execution components 613 for processing. Job execution components 613 in one example comprise a master executor 615 and agent executors 617. In one embodiment, the execution environment 602 may be executed on a container based computing environment, such as AWS®.

The following descriptions are intended to provide a brief general description of a suitable computing environment in which the methods and systems disclosed herein or portions thereof may be implemented. Although not required, the methods and systems disclosed herein are described in the general context of computer-executable instructions, such as program modules, being executed by a computer, such as a client workstation, server, personal computer, or mobile computing device such as a smartphone. Generally, program modules include routines, programs, objects, components, data structures and the like that perform particular tasks or implement particular abstract data types. Moreover, it should be appreciated the methods and systems disclosed herein and/or portions thereof may be practiced with other computer system configurations, including hand-held devices, multi-processor systems, microprocessor-based or programmable consumer electronics, network PCs, minicomputers, mainframe computers and the like. A processor may be implemented on a single-chip, multiple chips or multiple electrical components with different architectures. The methods and systems disclosed herein may also be practiced in distributed computing environments where tasks are performed by remote processing devices that are linked through a communications network. In a distributed computing environment, program modules may be located in both local and remote memory storage devices.

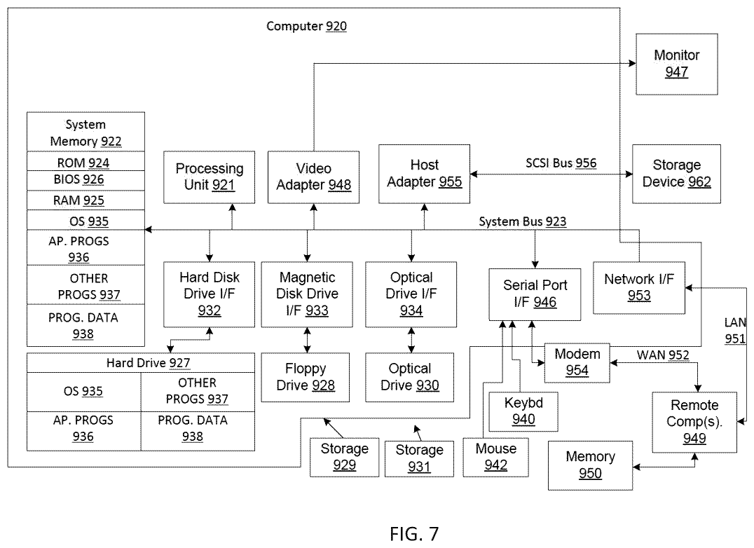

FIG. 7 is a block diagram representing a system in which aspects of the methods and systems disclosed herein and/or portions thereof may be incorporated. As shown, the exemplary general purpose computing system includes a computer 920 or the like, including a processing unit 921, a system memory 922, and a system bus 923 that couples various system components including the system memory to the processing unit 921. The system bus 923 may be any of several types of bus structures including a memory bus or memory controller, a peripheral bus, and a local bus using any of a variety of bus architectures. The system memory includes read-only memory (ROM) 924 and random access memory (RAM) 925. A basic input/output system 926 (BIOS), containing the basic routines that help to transfer information between elements within the computer 920, such as during start-up, is stored in ROM 924.

The computer 920 may further include a hard disk drive 927 for reading from and writing to a hard disk (not shown), a magnetic disk drive 928 for reading from or writing to a removable magnetic disk 929, and an optical disk drive 930 for reading from or writing to a removable optical disk 931 such as a CD-ROM or other optical media. The hard disk drive 927, magnetic disk drive 928, and optical disk drive 930 are connected to the system bus 923 by a hard disk drive interface 932, a magnetic disk drive interface 933, and an optical drive interface 934, respectively. The drives and their associated computer-readable media provide non-volatile storage of computer readable instructions, data structures, program modules and other data for the computer 920. As described herein, computer-readable media is a tangible, physical, and concrete article of manufacture and thus not a signal per se.

Although the exemplary environment described herein employs a hard disk, a removable magnetic disk 929, and a removable optical disk 931, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, magnetic disk 929, optical disk 931, ROM 924 or RAM 925, including an operating system 935, one or more application programs 936, other program modules 937 and program data 938. A user may enter commands and information into the computer 920 through input devices such as a keyboard 940 and pointing device 942. Other input devices (not shown) may include a microphone, joystick, game pad, satellite disk, scanner, or the like. These and other input devices are often connected to the processing unit 921 through a serial port interface 946 that is coupled to the system bus, but may be connected by other interfaces, such as a parallel port, game port, or universal serial bus (USB). A monitor 947 or other type of display device is also connected to the system bus 923 via an interface, such as a video adapter 948. In addition to the monitor 947, a computer may include other peripheral output devices (not shown), such as speakers and printers. The exemplary system of FIG. 4 also includes a host adapter 955, a Small Computer System Interface (SCSI) bus 956, and an external storage device 962 connected to the SCSI bus 956.

The computer 920 may operate in a networked environment using logical connections to one or more remote computers, such as a remote computer 949. The remote computer 949 may be a personal computer, a server, a router, a network PC, a peer device or other common network node, and may include many or all of the elements described above relative to the computer 920, although only a memory storage device 950 has been illustrated in FIG. 4. The logical connections depicted in FIG. 4 include a local area network (LAN) 951 and a wide area network (WAN) 952. Such networking environments are commonplace in offices, enterprise-wide computer networks, intranets, and the Internet.

When used in a LAN networking environment, the computer 920 is connected to the LAN 951 through a network interface or adapter 953. When used in a WAN networking environment, the computer 920 may include a modem 954 or other means for establishing communications over the wide area network 952, such as the Internet. The modem 954, which may be internal or external, is connected to the system bus 923 via the serial port interface 946. In a networked environment, program modules depicted relative to the computer 920, or portions thereof, may be stored in the remote memory storage device. It will be appreciated that the network connections shown are exemplary and other means of establishing a communications link between the computers may be used.

Computer 920 may include a variety of computer readable storage media. Computer readable storage media can be any available media that can be accessed by computer 920 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 920. Combinations of any of the above should also be included within the scope of computer readable media that may be used to store source code for implementing the methods and systems described herein. Any combination of the features or elements disclosed herein may be used in one or more examples.

In describing preferred examples of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A method comprising:
inputting data into a memory device;
applying a graph network model to the data to create a neural network;
parsing the neural network to divide the neural network into a plurality of subnetworks;
sending each subnetwork to a job execution component;
processing each subnetwork to produce a plurality of subnetwork scenarios;
superimposing the subnetwork scenarios to identify an optimum supply chain scenario; and
implementing the optimum supply chain scenario as a plan.

2. The method of claim 1, wherein the data is supply chain data and the neural network represents a supply chain for one or more products or services.

3. The method of claim 1, wherein sending each subnetwork to a job execution component comprises sending each subnetwork to a corresponding independent job execution component.

4. The method of claim 3, wherein sending each subnetwork to a job execution component further comprises utilizing an executor controller to select one or more job execution components to process each subnetwork.

5. The method of claim 4, wherein the job execution component comprises at least one master executor and at least one agent executor.

6. The method of claim 5, further comprising releasing the job execution component into a pool of available job execution components upon completion of processing each subnetwork.

7. The method of claim 6, further comprising receiving the supply chain data is received from a customer relationship management (CRM) application.

8. A system comprising:
a CRM application;
a container based computing environment; and
a polymatic solver application that:
receives data from the CRM application;
analyzes the data to create a model of a supply chain network;
sends the model to a container-based computing environment which is utilized to create an optimal supply chain management plan.

9. The system of claim 8, wherein the data from the CRM application is sales data.

10. The system of claim 8, wherein the polymatic solver application analyzes the data by applying a graph network model to the data to create a neural network that represents the supply chain network.

11. The system of claim 10, wherein the polymatic solver application parses the neural network to divide the neural network into a plurality of subnetworks.

12. The system of claim 11, wherein the plurality of subnetworks each comprise one or more demands for a product.

13. The system of claim 12, wherein the plurality of subnetworks comprise a first subnetwork and a second subnetwork and the demands in the first subnetwork are distinct from the demands in the second subnetwork.

14. A method, comprising:
receiving data representing orders for a product or service;
determining a bill or material for the product or service that includes a plurality of subcomponent demands for the product or service, which are elements needed to fulfill the product or service;
utilizing a graph network model to model the subcomponent demands into a neural network;
analyzing the neural network to determine if the neural network can be split into subnetworks; and
splitting the neural network into subnetworks if the neural network can be split;
sending data representing the subnetworks to a container-based execution environment;
utilizing the container-based execution environment to create an optimal supply chain plan for each of the subnetworks; and
assembling the optimal supply chain plans into a single supply chain plan.

15. The method of claim 14, wherein receiving data comprises receiving data from a CRM platform.

16. The method of claim 14, wherein analyzing comprises determining if there are subcomponent demands that can be fulfilled independently of each other.

17. The method of claim 14, wherein the subnetworks comprise a first subnetwork and a second subnetwork.

18. The method of claim 17, wherein a first job execution component creates a first supply chain plan for the first subnetwork and a second job execution component creates a second supply chain plan for the second subnetwork.

19. The method of claim 18, wherein the first job execution component and the second job execution component each comprise a master executor and an agent executor.

20. The method of claim 19, wherein an executor controller selects the first job execution component and the second job execution component.
